(19) United States
(12) Patent Application Publication
(10) Pub. No.: US 2007/0228222 A1
(43) Pub. Date: Oct. 4, 2007

(54) Method of improving lift of an aircraft wing

(76) Inventor: Mark William Davis, Edmonton (CA)

Correspondence Address: DAVIS & BUJOLD, P.L.L.C., 112 PLEASANT STREET, CONCORD, NH, 03301, US

(21) Appl. No.: 11/545,144

(22) Filed: Oct. 10, 2006

(30) Foreign Application Priority Data
Apr. 4, 2006 (CA) 2,542,920

(51) Int. Cl. B64C 21/04

(52) U.S. Cl. 244/207

(57) ABSTRACT

A method of improving lift of an aircraft wing. The method consists of a single step of mechanically generating a supplemental laminar air flow over the aircraft wing with a view to creating an area of low pressure over the aircraft wing which serves to enhance lift properties of the aircraft wing.

This application claims priority from Canadian Application Serial No. 2,542,920 filed Apr. 4, 2006.

### FIELD OF THE INVENTION

The present invention relates to a method of improving lift of an aircraft wing.

### BACKGROUND OF THE INVENTION

When an aircraft wing begins to lose lift, the aircraft experiences a loss in manoeuvrability. U.S. Pat. No. 5,772,155 (Nowak 1998) is an example of an invention developed to provide enhanced lift and manoeuvrability to an aircraft wing. The Nowak patent teaches the positioning of supplemental delta flaps on the wings.

### SUMMARY OF THE INVENTION

According to the present invention there is provided a method of improving lift of an aircraft wing. The method consists of a single step of mechanically generating a supplemental laminar air flow over the aircraft wing with a view to creating an area of low pressure over the aircraft wing which serves to enhance lift properties of the aircraft wing.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is a side elevation view, in section, of a first aircraft wing modified in accordance with the teachings of the present invention.

FIG. 2 is a side elevation view, in section, of a second aircraft wing modified in accordance with the teachings of the present invention.

### DETAILED DESCRIPTION OF THE PREFERRED EMBODIMENT

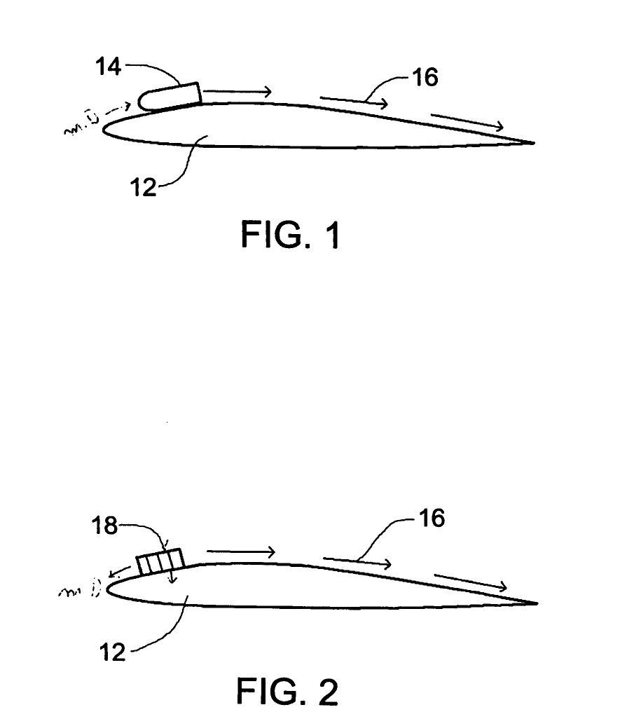

The preferred method will now be described with reference to FIG. 1 and 2.

Structure and Operation:

Referring to FIG. 1, there is shown a cross-section of an aircraft wing 12. There is positioned on top of aircraft wing 12 a turbine 14 which is used to mechanically generate a supplemental laminar air flow indicated by arrows 16 over aircraft wing 12 when extra lift or control is desired, for example, during take-off or landing. This is done with a view to creating an area of low pressure over the aircraft wing which serves to enhance the lift properties of aircraft wing 12. Referring to FIG. 2, an impeller 18 may be used instead of turbine 14. It will be apparent that other means of mechanically generating a supplemental laminar airflow may also be used.

Advantages:

The present method could be termed a “mechanically induced laminar overdraft vacuum enhancement”. The mechanically induced laminar overdraft directly induces significant lift over an aircraft wing. This is even true for a vertical takeoff aircraft at negligible forward velocity. In the absence of an offsetting laminar under draft, the mechanically induced laminar overdraft is an efficient and viable producer of lift by “vacuum enhancement” over the aircraft wing. Although a turbine and an impeller have been chosen for illustration, it will be understood that are any number of suitable ways of mechanically generating the laminar overdraft.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope of the invention as hereinafter defined in the Claims.

What is claimed is:

1. A method of improving lift of an aircraft wing, comprising a step of:
mechanically generating a supplemental laminar air flow over the aircraft wing with a view to creating an area of low pressure over the aircraft wing which serves to enhance lift properties of the aircraft wing.

2. The method as defined in claim 1, wherein the laminar air flow is mechanically generated by a turbine.

3. The method as defined in claim 1, wherein the laminar air flow is mechanically generated by an impeller.
